(19) United States
(12) Patent Application Publication
(10) Pub. No.: US 2025/0052062 A1
(43) Pub. Date: Feb. 13, 2025

(54) SEALANT POUCH SYSTEM FOR ADHERING ROOFING SHINGLES

(71) Applicant: BMIC LLC, Dallas, TX (US)

(72) Inventors: David Ellis, Perkasie, PA (US); Ming-Liang Shiao, Collegeville, PA (US); Brian Lee, Cranford, NJ (US)

(21) Appl. No.: 18/799,118

(22) Filed: Aug. 9, 2024

Related U.S. Application Data
(60) Provisional application No. 63/518,412, filed on Aug. 9, 2023.

(51) Int. Cl. E04D 1/00; C09J 5/08; C09J 9/00; C09J 175/04; C09J 195/00; E04D 1/12

(52) U.S. Cl. CPC E04D 1/29; C09J 5/08; C09J 9/00; C09J 175/04; C09J 195/00; E04D 1/12

(57) ABSTRACT

A sealant pouch system for adhering roofing shingles includes a plurality of pouches containing an adhesive with a viscosity of 25 cps to 2500 cps. Each pouch comprises an outer film that encases the adhesive and is configured to rupture when subjected to a sufficient force or a temperature above a predetermined threshold. The method of installation involves placing the pouches on the reveal portion of shingles in a first row, installing a second row of shingles to overlap the first row, and applying sufficient force to rupture the pouches, causing the adhesive to contact both the headlap and reveal portions of the shingles, thereby sealing the rows together. The pouches may have various shapes and are designed to prevent rolling or sliding off sloped roof decks.

### CROSS-REFERENCE TO RELATED APPLICATION

This application relates to and claims the benefit of commonly owned, co-pending U.S. provisional application Ser. No. 63/518,412, filed on Aug. 9, 2023, entitled “Roofing System Including Roofing Shingles,” the contents of which are incorporated herein by reference in their entirety.

### FIELD

In some embodiments, the present invention relates to a sealant pouch system for sealing a construction material to a surface. In some embodiments, the construction material relates to a roofing system, and, more particularly, to a roofing system that includes roofing shingles.

### BACKGROUND

In a known roofing system, an installer installs overlapping rows of roofing shingles on a roof deck. Each of the roofing shingles includes one or more lines of asphaltic adhesive on a bottom surface of the reveal portion. When the sun, for example, heats the roofing shingles and thus the lines of asphaltic adhesive to a sufficient temperature, the lines of asphaltic adhesive seal the overlapping rows of roofing shingles to one another.

### SUMMARY

In some embodiments, a method installation comprises obtaining a plurality of roofing shingles, wherein each shingle of the plurality of shingles includes a reveal portion and a headlap portion; obtaining a plurality of adhesive pouches, wherein each pouch comprises an adhesive and an outer film encasing the adhesive, wherein the outer film is configured to rupture when subjected to a sufficient force; installing the first plurality of shingles on a roof so as to form a first row; placing at least one adhesive pouch on the reveal portion of each shingle in the first row; installing a second plurality of shingles on the roof to form a second row, wherein the headlap portion of each shingle of the second row of shingles are installed over the reveal portion of each shingle of the first row resulting in the second row overlapping the first row; wherein at least a portion of the headlap of the second row directly contacts the sealant pouch; applying a sufficient force to the second row of shingles so the pouch ruptures and results in the adhesive directly contacting both the headlap of each shingle of the second row and the reveal portion of each shingle of the first row; and sealing the second row of shingles to the first row of shingles.

In some embodiments, the method wherein the adhesive has a viscosity of 50 cps to 2000 cps. In some embodiments, the method wherein the adhesive is a hot melt adhesive. In some embodiments, the method wherein the adhesive is a solvent-based adhesive. In some embodiments, the method wherein the outer film is made of a thermoplastic polymer. In some embodiments, the method wherein the thermoplastic polymer is a polyolefin. In some embodiments, the method wherein the outer film is configured to degrade, melt, and/or disintegrate at a temperature of more than 100 degrees Fahrenheit. In some embodiments, the method wherein the adhesive pouch is textured to prevent rolling or sliding off a sloped roof deck. In some embodiments, the method wherein the adhesive adheres the roofing shingles within three hours of release.

In some embodiments, a method installation comprises obtaining a plurality of roofing shingles, wherein each shingle of the plurality of shingles includes a reveal portion and a headlap portion; obtaining a plurality of adhesive pouches, wherein each pouch comprises an adhesive and an outer film encasing the adhesive, wherein the outer film is configured to rupture when subjected to a temperature above a predetermined threshold; installing the first plurality of shingles on a roof so as to form a first row; placing at least one adhesive pouch on the reveal portion of each shingle in the first row; installing a second plurality of shingles on the roof to form a second row, wherein the headlap portion of each shingle of the second row of shingles are installed over the reveal portion of each shingle of the first row resulting in the second row overlapping the first row; wherein at least a portion of the headlap of the second row directly contacts the sealant pouch; allowing the temperature of the adhesive pouches to rise above the predetermined threshold, causing the outer film to rupture and the adhesive to be released, contacting both the headlap portion of the shingles in the second row and the reveal portion of the shingles in the first row; and sealing the second row of shingles to the first row of shingles.

In some embodiments, a method of installation comprises installing at least one shingle defining a headlap portion and a reveal portion, wherein each having opposed upper and lower surfaces; placing at least one adhesive pouch on the lower surface of the reveal portion, wherein the adhesive pouch comprises an adhesive with a viscosity of 25 cps to 2500 cps and an outer film encasing the adhesive, wherein the outer film is configured to rupture when subjected to a sufficient force; applying a sufficient force to the shingle so the pouch ruptures and results in the adhesive directly contacting both the reveal portion; and sealing the shingle to a roof substate.

In some embodiments, a sealant pouch comprises an adhesive with a viscosity of 25 cps to 2500 cps and an outer film encasing the adhesive, wherein the outer film is configured to rupture when subjected to a temperature above a predetermined threshold.

In some embodiments, a sealant pouch comprises an adhesive with a viscosity of 25 cps to 2500 cps and an outer film encasing the adhesive, wherein the outer film is configured to rupture when subjected to a sufficient force that is equivalent to walking on a shingle.

### BRIEF DESCRIPTION

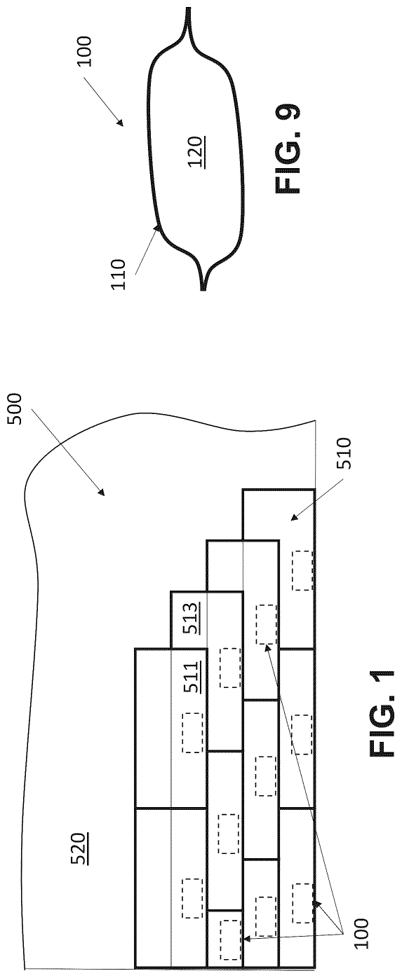

FIG. 1 is a schematic top view of a roofing system including roofing shingles installed on a roof deck, according to some embodiments.

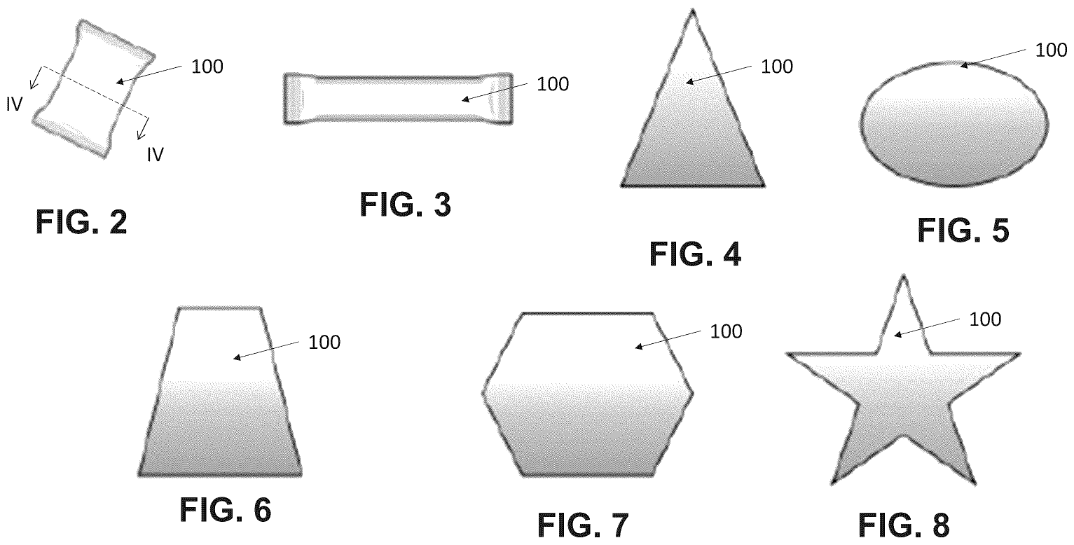

FIG. 2 is a schematic top view of a pouch, according to some embodiments of the invention.

FIG. 3 is a schematic top view of a pouch, according to some embodiments of the invention.

FIG. 4 is a schematic top view of a pouch, according to some embodiments of the invention.

FIG. 5 is a schematic top view of a pouch, according to some embodiments of the invention.

FIG. 6 is a schematic top view of a pouch, according to some embodiments of the invention.

FIG. 7 is a schematic top view of a pouch, according to some embodiments of the invention.

FIG. 8 is a schematic top view of a pouch, according to some embodiments of the invention.

FIG. 9 is a schematic cross-sectional view of the pouch of FIG. 2, taken along line IV-IV, according to some embodiments of the invention.

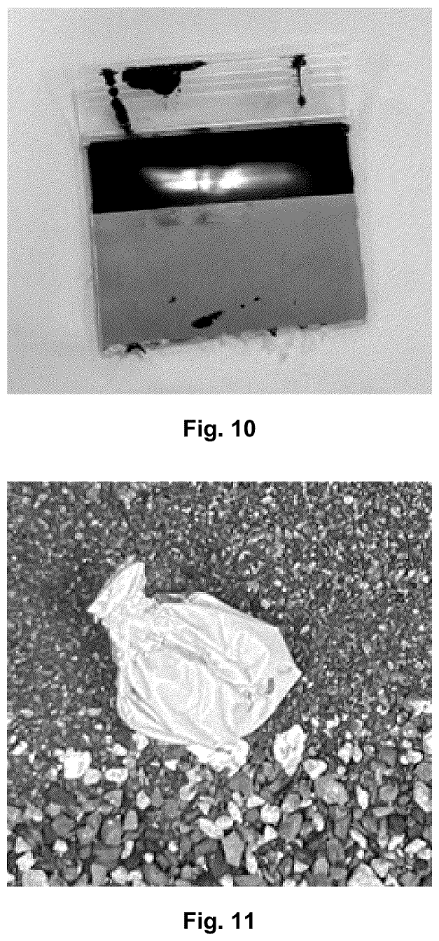

FIG. 10 is a photograph of a pouch having a rectangular shape, according to some embodiments of the invention.

FIG. 11 is a photograph of a pouch having a hexagonal shape, according to some embodiments of the invention.

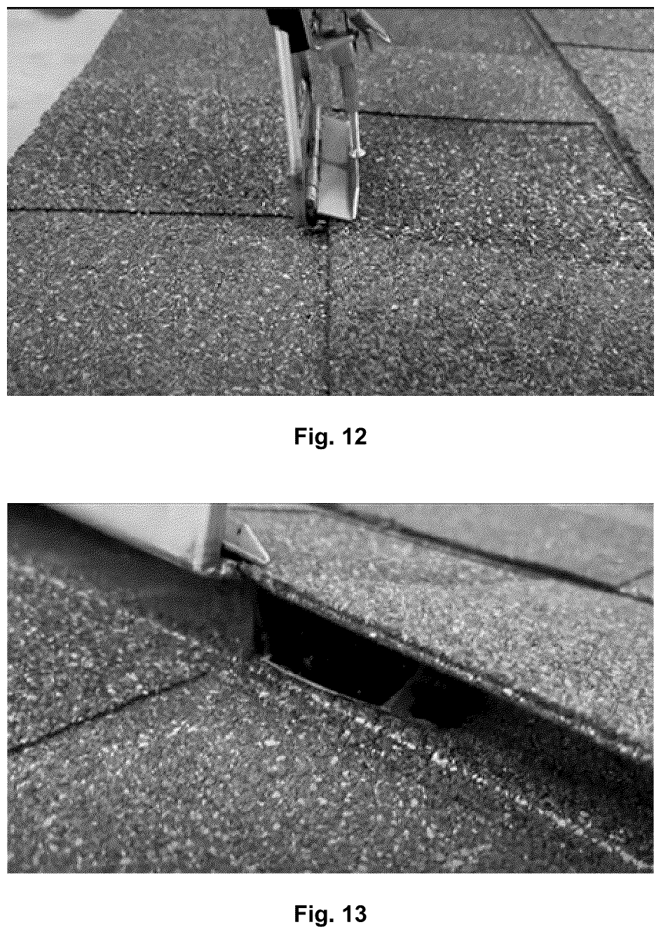

FIGS. 12 and 13 are photographs of shingles subjected to the uplift test where the pouch was inserted, according to some embodiments of the invention.

### DETAILED DESCRIPTION

In addition to the benefits and improvements that the Specification discloses, other objects and advantages that the Specification provides will become apparent from the following description taken in conjunction with the accompanying figures. Although the description discloses and describes detailed embodiments of the present disclosure, the disclosed embodiments are merely illustrative of the disclosure that is embodied in various forms. In addition, each of the examples given regarding the various embodiments of the disclosure is intended to be illustrative, and not restrictive.

As used herein, a “steep slope” roof or roof deck is a roof or roof deck having a pitch of Y/X, where Y and X are in a ratio of 4:12 to 20:12, where Y corresponds to the “rise” of the roof or roof deck, and where X corresponds to the “run” of the roof or roof deck.

As used herein, a “sloped” roof or roof deck is a roof or roof deck having a pitch greater than zero, but the pitch is less than that of a steep slope roof or roof deck.

With reference to the figures, FIG. 1 shows a roofing system including a plurality of roofing shingles installed on a roof deck, according to some embodiments of the invention. As the figure shows, in some embodiments, a roofing system 500 includes a plurality of roofing shingles 510 installed on a roof deck 520.

In some embodiments, the roof deck 520 is a sloped roof deck. In some embodiments, the sloped roof deck is a steep slope roof deck.

In some embodiments, each of the roofing shingles 510 includes a reveal portion 511 and a headlap portion 513. In some embodiments, the reveal portions 511 of the roofing shingles 510 in one shingle row (e.g., an upper shingle row) overlap the headlap portions 513 of the roofing shingles 510 in another shingle row (e.g., a lower shingle row).

In some embodiments, as illustrated by FIG. 1, a plurality of pouches containing an adhesive 100 are placed between the reveal portions 511 of the roofing shingle 510 in one shingle row, and the headlap portion 513 of the roofing shingles 510 in another shingle row, thereby to seal the reveal portions 511 to the headlap portions 513. In some embodiments, the pouches containing an adhesive 100 seal the reveal portions 511 of roofing shingle 510 in one shingle row, and the headlap portion 513 of roofing shingles in another shingle row, in addition to the seal provided by the one or more lines of asphaltic adhesive. In some embodiments, the pouches containing an adhesive 100 seal the reveal portions 511 to the headlap portion 513 at a lower temperature than a temperature at which the one or more lines of asphaltic adhesive seal the reveal portions 511 to the headlap portions 513.

In some embodiments, each of the roofing shingles 510 includes a plurality of pouches containing an adhesive. In some embodiments, the plurality of pouches is on a bottom surface of the reveal portion 511 of each of the roofing shingles 510. In some embodiments, when the sun heats the plurality of pouches containing an adhesive to a sufficient temperature, the pouches containing an adhesive seal the reveal portions 511 to the headlap portions 513.

FIGS. 2-8 show exemplary shapes of the pouches 100, in accordance with some embodiments of the invention. As the figures show, in some embodiments, the pouches 100 have a quadrilateral shape (such as but not limited to the rectangles in FIGS. 2 and 3), a triangle shape (such as but not limited to the isosceles triangle in FIG. 4), an arcuate shape (such as but not limited to the elliptical shape in FIG. 5), a trapezoid shape (such as but not limited to the isosceles trapezoid of FIG. 6), a polygon shape (such as but not limited to the hexagon of FIG. 7), and/or a star shape (such as but not limited to the star of FIG. 8). Although the figures show exemplary shapes, in some embodiments, the pouches 100 are another shape, such as combinations of two or more of the illustrated shapes, and/or different shapes.

As shown in FIG. 9, which is a cross-sectional view of the pouch 100 from FIG. 2, in some embodiments, the pouches 100 include an outer film 110 defining an interior. In some embodiments, the pouches include an adhesive 120 within the interior defined by the outer film 110. The adhesive 120 seals the reveal portions 511 of an upper shingle row of the roofing shingles 510 to the headlap portion 513 of a lower shingle row of the roofing shingles 510, as described.

In some embodiments, the adhesive 120 includes at least one of a hot melt adhesive, a solvent-based adhesive, a pressure sensitive adhesive, a water-based adhesive, a UV cured or UV curable polymer, or any combination thereof. In some embodiments, the adhesive 120 include at least one of an asphaltic adhesive, a butyl adhesive, a silicone adhesive, an acrylic adhesive, a synthetic thermoplastic elastomer, a natural rubber, or any combination thereof. In some embodiments, the adhesive 120 includes at least one of thermosetting polyolefin, thermoplastic polyolefin (TPO), polyvinyl butyrate, silicone, polycarbonate, butyl rubber, styrene-butadiene-styrene (SBS), styrene-isoprene-styrene (SIS), styrene butadiene (SB), styrene-ethylene-butadiene-styrene (SEBS), ethylene vinyl acetate (EVA), a resin, a hydrocarbon resin, a rosin resin, a natural wax, a petroleum wax, an oil, bitumen, a solvent, vinyl acetate, an acrylic polymers, an acrylic copolymer, (e.g., at least one of vinyl acetate acrylic, ethylene vinyl acetate, styrene acrylic, vinyl chloride acrylic, vinyl versatate, or any combination thereof), or any combination thereof. In some embodiments, the adhesive 120 includes at least one elastomer. In some embodiments, the at least one elastomer comprises at least one of a butyl rubber, a styrenic block copolymer, or any combination thereof. In some embodiment, the adhesive may be a heat-sensitive, pressure sensitive, thermally activated or any combination thereof. In some embodiments where the adhesive is a moisture-sensitive adhesive, when the adhesive is released, the adhesive is exposed to moisture and is thus moisture cured. In some embodiments where the adhesive is a heat-cured adhesive, when the adhesive is released, the adhesive is exposed to heat and is thus heat cured.

In some embodiments, the pouches outer film 110 have an affinity for the roofing shingles 510. In some embodiments, the pouches outer film 110 have a strong chemical affinity for the roofing shingles 510. In some embodiments, the pouches outer film 110 has an affinity for a surface of the roofing shingles 510, such as but not limited the reveal portion 511 and/or the headlap portion 513.

In some embodiments, the outer film 110 may include at least one polymer. In some embodiments, the at least one polymer may comprise, consist of, or consist essentially of at least one thermoplastic polymer, at least one recycled polymer, or any combination thereof. In some embodiments, the at least one thermoplastic polymer may comprise, consist of, or consist essentially of a polyolefin, a vinyl polymer, or any combination thereof. In some embodiments, the polyolefin may comprise, consist of, or consist essentially of polyethylene, polypropylene, or any combination thereof, such as, for example and without limitation, a copolymer of ethylene and propylene. In some embodiments, the polyolefin may comprise, consist of, or consist essentially of a copolymer of ethylene and an alpha-olefin, such as, for example and without limitation, ethylene and 1-octene, ethylene and 1-hexene, and ethylene and 1-butene. In some embodiments, the vinyl polymer may comprise, consist of, or consist essentially of a polyvinyl ester. In some embodiments, the vinyl polymer may comprise, consist of, or consist essentially of polyvinyl butyral (PVB). In some embodiments, the thermoplastic polymer may comprise, consist of, or consist essentially of a thermoplastic elastomer.

Some non-limiting examples of the at least one polymer (e.g., such as, one or more of thermoplastic polymers, polyolefins, vinyl polymers, polyvinyl esters, thermoplastic elastomers, recycled polymers, etc.) may include, without limitation, one or more of the following: polyethylenes (PE) (e.g., including, without limitation, one or more of raw low density polyethylene, recycled low density polyethylene (LDPE), linear low density polyethylene (LLDPE), and high density polyethylene (HDPE)), polypropylene (PP) (e.g., including, without limitation, one or more of isotactic polypropylene (IPP), atactic polypropylene/isotactic propylene (APP/IPP)), polystyrene, polyurethane (PU/TPU), polyurea, terpolymers (e.g., including, without limitation, a functionalized polymer with a reactive oxygen group), amorphous polyalpha olefins (APAO), amorphous polyolefins (APO), (e.g., including, without limitation, one or more of propylene homopolymers, copolymers of propylene and ethylene, copolymers of ethylene alpha-olefin, such as ethylene and 1-octene, ethylene and 1-hexene, and ethylene and 1-butene), polyolefin elastomers (POE), styrene/styrenic block copolymers (e.g., including, without limitation, one or more of styrenic block copolymers with a hydrogenated midblock of styrene-ethylene/butylene-styrene (SEBS), styrene-ethylene/propylene-styrene (SEPS), styrene-isoprene-styrene block copolymers (SIS), and styrene-butadiene-styrene block copolymers (SBS)), ethylene vinyl acetate (EVA), polyisobutylene, polybutadiene, oxidized polyethylene, epoxy thermoplastics, raw polyvinyl butyral (PVB), recycled polyvinyl butyral (rPVB), polyvinyl acetate (PVAC), poly (vinyl butyrate), poly (vinyl propionate), poly (vinyl formate), and copolymers of PVAC (e.g., including, without limitation, copolymers of PVAC and EVA). Some non-limiting examples of the at least one polymer (e.g., including, without limitation, thermoplastic polymers, polyolefins, vinyl polymers, polyvinyl esters, and thermoplastic elastomers) may include, without limitation, one or more of the following: Vistamaxx® 6102 and Vistamaxx® 8880, which are polypropylenes (e.g., isotactic polypropylene (IPP)) and which are available from ExxonMobil, Irving, Tex.; Elvaloy®, which is a terpolymer and which is available from Dow/DuPont, Wilmington, Del.; Fusabond®, which is a chemically modified ethylene acrylate copolymer, a modified polyethylene, or a combination thereof and which is available from Dow/DuPont, Wilmington, Del.; RT2304, which is an amorphous polyalpha olefin (APAO) and which is available from Rextac APAO Polymers LLC, Odessa, Tex.; Eastoflex® P1023, which is an amorphous polyolefin (APO) comprising a propylene homopolymer and which is available from Eastman Chemical Company, Kingsport, Tenn.; Eastoflex® E1060, which is an amorphous polyolefin (APO) comprising a copolymer of propylene and ethylene and which is available from Eastman Chemical Company, Kingsport, Tenn.; Eastoflex® M1025, which is an amorphous polyolefin (APO) that comprises a blend of propylene homopolymer and copolymers of propylene and ethylene and which is available from Eastman Chemical Company, Kingsport, Tenn.; Engage® 7487, which is a polyolefin elastomer (POE) and which is available from Dow Inc., Midland, Mich.; SEBS 1657, which is a linear triblock copolymer based on styrene and ethylene/butylene, namely, styrene-ethylene/butylene-styrene (SEBS) and which is available Kraton™ Corporation, Houston, Tex.; D0243, D0246, D1101, D1102, D1116, D1118, D1152, D1155, D1157, D1184, D1189, D1191, and D1194, which are styrene butadiene styrene block copolymers comprising blocks of styrene and butadiene and which is available Kraton™ Corporation, Houston, Tex.; PI131350, which is a polyisobutylene and which is available from TPC Group, Houston, Tex.; ethylene bis stearamide (EBS), which is available from ACME-Hardesty Company, Blue Bell, Pa.; IPP, which is available from Bay Polymer Corp., Fremont, Calif.; and recycled low density polyethylene, which is available from Avangard Innovative, Houston, Tex.

In some embodiments, the outer film 110 bursts or ruptures when the pouch 100 and/or the outer film 110 is subjected to a sufficient force, and the adhesive 120 within the interior of the outer film 110 flows out of the interior of the outer film 110. Thus, in some embodiments, when the pouches 100 are between the reveal portions 5110 and the headlap portions 513 of the roofing shingles 510, and the pouches 100 are subjected to a sufficient force, the adhesive 120 flows out of the outer film 110, and flows between the reveal portions 511 of the roofing shingle 510 in one shingle row, and the headlap portions 513 of the roofing shingles 510 in another shingle row and thus seals the reveal portions 511 of the roofing shingle 510 in one shingle row, and the headlap portions 513 of the roofing shingles 510 in another shingle row.

In some embodiments, the outer film 110 ruptures upon the application of a sufficient force. In some embodiments, the outer film 110 ruptures when a person walks on the roofing shingles 510, under which the pouches 100 are placed.

In some embodiments, one of the pouches 100 is placed under each of the reveal portions 511, such as by the installer. In some embodiments, more than one of the pouches 100 are placed under each of the reveal portions 511. In some embodiments, when the roofing shingles 510 include a number of tabs, one of the pouches 100 is placed under each of the tabs. In some embodiments, more one of the pouches 100 are placed under each of the tabs.

In some embodiments, the adhesive 120 has a viscosity more than 25 cps. In some embodiments, the adhesive 120 has a viscosity more than 50 cps. In some embodiments, the adhesive 120 has a viscosity more than 75 cps. In some embodiments, the adhesive 120 has a viscosity more than 100 cps. In some embodiments, the adhesive 120 has a viscosity more than 200 cps. In some embodiments, the adhesive 120 has a viscosity more than 300 cps. In some embodiments, the adhesive 120 has a viscosity more than 400 cps. In some embodiments, the adhesive 120 has a viscosity more than 500 cps. In some embodiments, the adhesive 120 has a viscosity more than 750 cps. In some embodiments, the adhesive 120 has a viscosity more than 1000 cps. In some embodiments, the adhesive 120 has a viscosity more than 1250 cps. In some embodiments, the adhesive 120 has a viscosity more than 1500 cps. In some embodiments, the adhesive 120 has a viscosity more than 1750 cps. In some embodiments, the adhesive 120 has a viscosity more than 2000 cps. In some embodiments, the adhesive 120 has a viscosity more than 2225 cps. In some embodiments, the adhesive 120 has a viscosity more than 2500 cps.

In some embodiments, the adhesive 120 has a viscosity of 25 cps to 2500 cps. In some embodiments, the adhesive 120 has a viscosity of 50 cps to 2500 cps. In some embodiments, the adhesive 120 has a viscosity of 75 cps to 2500 cps. In some embodiments, the adhesive 120 has a viscosity of 100 cps to 2500 cps. In some embodiments, the adhesive 120 has a viscosity of 200 cps to 2500 cps. In some embodiments, the adhesive 120 has a viscosity of 300 cps to 2500 cps. In some embodiments, the adhesive 120 has a viscosity of 400 cps to 2500 cps. In some embodiments, the adhesive 120 has a viscosity of 500 cps to 2500 cps. In some embodiments, the adhesive 120 has a viscosity of 750 cps to 2500 cps. In some embodiments, the adhesive 120 has a viscosity of 1000 cps to 2500 cps. In some embodiments, the adhesive 120 has a viscosity of 1250 cps to 2500 cps. In some embodiments, the adhesive 120 has a viscosity of 1500 cps to 2500 cps. In some embodiments, the adhesive 120 has a viscosity of 1750 cps to 2500 cps. In some embodiments, the adhesive 120 has a viscosity of 2000 cps to 2500 cps. In some embodiments, the adhesive 120 has a viscosity of 2225 cps to 2500 cps.

In some embodiments, the adhesive 120 has a viscosity of 25 cps to 2000 cps. In some embodiments, the adhesive 120 has a viscosity of 50 cps to 2000 cps. In some embodiments, the adhesive 120 has a viscosity of 75 cps to 2000 cps. In some embodiments, the adhesive 120 has a viscosity of 100 cps to 2000 cps. In some embodiments, the adhesive 120 has a viscosity of 200 cps to 2000 cps. In some embodiments, the adhesive 120 has a viscosity of 300 cps to 2000 cps. In some embodiments, the adhesive 120 has a viscosity of 400 cps to 2000 cps. In some embodiments, the adhesive 120 has a viscosity of 500 cps to 2000 cps. In some embodiments, the adhesive 120 has a viscosity of 750 cps to 2000 cps. In some embodiments, the adhesive 120 has a viscosity of 1000 cps to 2000 cps. In some embodiments, the adhesive 120 has a viscosity of 1250 cps to 2000 cps. In some embodiments, the adhesive 120 has a viscosity of 1500 cps to 2000 cps. In some embodiments, the adhesive 120 has a viscosity of 1750 cps to 2000 cps.

In some embodiments, the adhesive 120 has a viscosity of 25 cps to 1500 cps. In some embodiments, the adhesive 120 has a viscosity of 50 cps to 1500 cps. In some embodiments, the adhesive 120 has a viscosity of 75 cps to 1500 cps. In some embodiments, the adhesive 120 has a viscosity of 100 cps to 1500 cps. In some embodiments, the adhesive 120 has a viscosity of 200 cps to 1500 cps. In some embodiments, the adhesive 120 has a viscosity of 300 cps to 1500 cps. In some embodiments, the adhesive 120 has a viscosity of 400 cps to 1500 cps. In some embodiments, the adhesive 120 has a viscosity of 500 cps to 1500 cps. In some embodiments, the adhesive 120 has a viscosity of 750 cps to 1500 cps. In some embodiments, the adhesive 120 has a viscosity of 1000 cps to 1500 cps. In some embodiments, the adhesive 120 has a viscosity of 1250 cps to 1500 cps.

In some embodiments, the adhesive 120 has a viscosity of 25 cps to 1000 cps. In some embodiments, the adhesive 120 has a viscosity of 50 cps to 1000 cps. In some embodiments, the adhesive 120 has a viscosity of 75 cps to 1000 cps. In some embodiments, the adhesive 120 has a viscosity of 100 cps to 1000 cps. In some embodiments, the adhesive 120 has a viscosity of 200 cps to 1000 cps. In some embodiments, the adhesive 120 has a viscosity of 300 cps to 1000 cps. In some embodiments, the adhesive 120 has a viscosity of 400 cps to 1000 cps. In some embodiments, the adhesive 120 has a viscosity of 500 cps to 1000 cps. In some embodiments, the adhesive 120 has a viscosity of 750 cps to 1000 cps.

In some embodiments, the adhesive 120 has a viscosity of 25 cps to 500 cps. In some embodiments, the adhesive 120 has a viscosity of 50 cps to 500 cps. In some embodiments, the adhesive 120 has a viscosity of 75 cps to 500 cps. In some embodiments, the adhesive 120 has a viscosity of 100 cps to 500 cps. In some embodiments, the adhesive 120 has a viscosity of 200 cps to 500 cps. In some embodiments, the adhesive 120 has a viscosity of 300 cps to 500 cps. In some embodiments, the adhesive 120 has a viscosity of 400 cps to 500 cps.

In some embodiments, the viscosity is measured at a temperature of 32 degrees Fahrenheit. In some embodiments, the viscosity is measured at a temperature other than 32 degrees Fahrenheit. In some embodiments, the viscosity is measured at a temperature of more than 32 degrees Fahrenheit. In some embodiments, the viscosity is measured at a temperature of less than 32 degrees Fahrenheit.

In some embodiments, the adhesive 120 adheres the roofing shingles 510, thereby providing wind uplift resistance. In some embodiments, the adhesive 120 adheres the reveal portions 511 of the roofing shingles 510 in one shingle row to the headlap portions 513 of the roofing shingles 510 in another shingle row, thereby to provide wind uplift resistance. In some embodiments, the adhesive 120 adheres the roofing shingles 510 at a lower temperature than a temperature at which another adhesive on the roofing shingle 510, such as the lines of adhesive on the bottom surface of the reveal portion 511, adheres the roofing shingles 510 to one another. In some embodiments, the adhesive 120 adheres the roofing shingles 510 to one another at a temperature of 32 degrees Fahrenheit. In some embodiments, the adhesive 120 adheres the roofing shingles 510 to one another at a temperature other than 32 degrees Fahrenheit. In some embodiments, the adhesive 120 adheres the roofing shingles 510 to one another at a temperature of more than 32 degrees Fahrenheit. In some embodiments, the adhesive 120 adheres the roofing shingles 510 to one another at a temperature of less than 32 degrees Fahrenheit.

In some embodiments, the adhesive 120 is capable of adhering the roofing shingles 510 to one another when the temperature is less than 50 degrees Fahrenheit. In some embodiments, the adhesive 120 is capable of adhering the roofing shingles 510 to one another when the temperature is less than 40 degrees Fahrenheit. In some embodiments, the adhesive 120 is capable of adhering the roofing shingles 510 to one another when the temperature is less than 32 degrees Fahrenheit. In some embodiments, the adhesive 120 is capable of adhering the roofing shingles 510 to one another when the temperature is less than 30 degrees Fahrenheit. In some embodiments, the adhesive 120 is capable of adhering the roofing shingles 510 to one another when the temperature is less than 20 degrees Fahrenheit.

In some embodiments, the adhesive 120 adheres the roofing shingles 510 to one another within three hours of release (e.g., within three hours of flowing from the interior on the outer film 110 to between the reveal portions 511 and the headlap portion 513). In some embodiments, the adhesive 120 adheres the roofing shingles 510 to one another within two hours of release. In some embodiments, the adhesive 120 adheres the roofing shingles 510 to one another within one- and one-half hours of release. In some embodiments, the adhesive 120 adheres the roofing shingles 510 to one another within one hour of release.

In some embodiments, the adhesive 120 includes a solvent that evaporates.

In some embodiments, at least one surface of the pouches 100 is textured. In some embodiments, at least two surfaces (e.g., an upper surface and a lower surface) of the pouches 100 are textured. In some embodiments, the texturing is sufficient to prevent the pouches 100 from rolling or sliding off of a steep slope roof deck that has a pitch of 10:12 or less. In some embodiments, the texturing is sufficient to prevent the pouches 100 from rolling or sliding off of a steep slope roof deck that has a pitch of 9:12 or less. In some embodiments, the texturing is sufficient to prevent the pouches 100 from rolling or sliding off of a steep slope roof deck that has a pitch of 8:12 or less. In some embodiments, the texturing is sufficient to prevent the pouches 100 from rolling or sliding off of a steep slope roof deck that has a pitch of 7:12 or less. In some embodiments, the texturing is sufficient to prevent the pouches 100 from rolling or sliding off of a steep slope roof deck that has a pitch of 6:12 or less. In some embodiments, the texturing is sufficient to prevent the pouches 100 from rolling or sliding off of a steep slope roof deck that has a pitch of 5:12 or less. In some embodiments, the texturing is sufficient to prevent the pouches 100 from rolling or sliding off of a steep slope roof deck that has a pitch of 4:12 or less. In some embodiments, the texturing is sufficient to prevent the pouches 100 from rolling or sliding off of a sloped roof deck.

In some embodiments, the pouches 100 is shaped so as to prevent rolling or sliding off of the roof deck 520 when the roof deck 520 is a sloped roof deck. In some embodiments, the pouches 100 is shaped so as to prevent rolling or sliding off the roof deck 520 when the roof deck is a steep slope roof deck. In some embodiments, the pouches 100 is relatively flat.

In some embodiments, the largest dimension of the pouches 100 is more than 3 inches. In some embodiments, the largest dimension of the pouches 100 is less than 3 inches. In some embodiments, the largest dimension is less than 2 inches. In some embodiments, the largest dimension is less than 1 inch. In some embodiments, the largest is less than ¾ inch. In some embodiments, the largest dimension is less than ½ inch. In some embodiments, the largest dimension is less than ¼ inch. In some embodiments, the largest dimension is less than 3/16 inch. In some embodiments, the largest dimension is less than ⅛ inch. In some embodiments, the largest dimension is less than 1/16 inch.

In some embodiments, the largest dimension of the pouches 100 is 1/16 inch to 3 inches. In some embodiments, the largest dimension is 1/16 inch to 2 inches. In some embodiments, the largest dimension is 1/16 inch to 1 inch. In some embodiments, the largest is 1/16 inch to ¾ inch. In some embodiments, the largest dimension is 1/16 inch to ½ inch. In some embodiments, the largest dimension is 1/16 inch to ¼ inch. In some embodiments, the largest dimension is 1/16 inch to 3/16 inch. In some embodiments, the largest dimension is 1/16 inch to ⅛ inch.

In some embodiments, the largest dimension is ¼ inch to 3 inches. In some embodiments, the largest dimension is ¼ inch to 2 inches. In some embodiments, the largest dimension is ¼ inch to 1 inch. In some embodiments, the largest is ¼ inch to ¾ inch. In some embodiments, the largest dimension is ¼ inch to ½ inch.

In some embodiments, the largest dimension is ½ inch to 3 inches. In some embodiments, the largest dimension is ½ inch to 2 inches. In some embodiments, the largest dimension is ½ inch to 1 inch. In some embodiments, the largest is ½ inch to ¾ inch.

In some embodiments, the outer film 110 is configured to degrade, melt, and/or disintegrate at a predetermined threshold temperature. Examples of such predetermined threshold temperature are the following. In some embodiments, the outer film 110 is configured to degrade, melt, and/or disintegrate at a temperature of more than 110 degrees Fahrenheit. In some embodiments, the outer film 110 is configured to degrade, melt, and/or disintegrate at a temperature of more than 120 degrees Fahrenheit. In some embodiments, the outer film 110 is configured to degrade, melt, and/or disintegrate at a temperature of more than 130 degrees Fahrenheit. In some embodiments, the outer film 110 is configured to degrade, melt, and/or disintegrate at a temperature of more than 140 degrees Fahrenheit. In some embodiments, the outer film 110 is configured to degrade, melt, and/or disintegrate at a temperature of more than 150 degrees Fahrenheit. In some embodiments, the outer film 110 is configured to degrade, melt, and/or disintegrate at a temperature of more than 160 degrees Fahrenheit. In some embodiments, the outer film 110 is configured to degrade, melt, and/or disintegrate at a temperature of more than 170 degrees Fahrenheit.

In some embodiments, the outer film 110 is configured to degrade, melt, and/or disintegrate at a temperature of less than 100 degrees Fahrenheit. In some embodiments, the outer film 110 is configured to degrade, melt, and/or disintegrate at a temperature of less than 110 degrees Fahrenheit. In some embodiments, the outer film 110 is configured to degrade, melt, and/or disintegrate at a temperature of less than 120 degrees Fahrenheit. In some embodiments, the outer film 110 is configured to degrade, melt, and/or disintegrate at a temperature of less than 130 degrees Fahrenheit. In some embodiments, the outer film 110 is configured to degrade, melt, and/or disintegrate at a temperature of less than 140 degrees Fahrenheit. In some embodiments, the outer film 110 is configured to degrade, melt, and/or disintegrate at a temperature of less than 150 degrees Fahrenheit. In some embodiments, the outer film 110 is configured to degrade, melt, and/or disintegrate at a temperature of less than 160 degrees Fahrenheit. In some embodiments, the outer film 110 is configured to degrade, melt, and/or disintegrate at a temperature of less than 170 degrees Fahrenheit.

In some embodiments, the plurality of pouches includes at least a first pouch containing a first adhesive and a second pouch containing a second adhesive, where the first and second pouch comprise different adhesives and wherein the first adhesive is formulated to seal below a predetermined threshold temperature and the second adhesive is formulated to seal above a predetermined threshold activation temperature.

In some embodiments, after melting, the outer film 110 becomes a component of the roofing system 500. In some embodiments, after melting, the outer film 110 reinforces (e.g., strengthens) the seal provided by the lines of adhesive. In some embodiments, after melting, the outer film 110 reinforces a component, layer, or characteristic of the roofing shingles 510, such as but not limited to the asphalt coating.

In some embodiments, the outer film 110 retains the adhesive 120 in the interior (e.g., not leak, burst, or otherwise fail) when the temperature of the pouches 100 is either above or below a predetermined temperature threshold. Examples of such predetermined temperature threshold are the following. In some embodiments, the outer film 110 retains the adhesive 120 in the interior when the temperature of the pouches 100 is less than 32 degrees Fahrenheit. In some embodiments, the outer film 110 retains the adhesive 120 in the interior when an ambient temperature is 32 degrees Fahrenheit. In some embodiments, the outer film 110 retains the adhesive 120 in the interior when the ambient temperature is less than 32 degrees Fahrenheit. In some embodiments, the outer film 110 retains the adhesive 120 in the interior when temperature of the roofing shingles 510 and/or the roof deck 520 is 32 degrees Fahrenheit. In some embodiments, the outer film 110 retains the adhesive 120 in the interior when temperature of the roofing shingles 510 and/or the roof deck 520 is less than 32 degrees Fahrenheit.

In some embodiments, the outer film 110 retains the adhesive in the interior when the temperature of the pouches 100, the roofing shingles 510, and/or the roof deck 520, and/or when the ambient temperature, is 60 degrees Fahrenheit. In some embodiments, the outer film 110 retains the adhesive in the interior when the temperature of the pouches 100, the roofing shingles 510, and/or the roof deck 520, and/or when the ambient temperature, is 50 degrees Fahrenheit. In some embodiments, the outer film 110 retains the adhesive in the interior when the temperature of the pouches 100, the roofing shingles 510, and/or the roof deck 520, and/or when the ambient temperature, is 40 degrees Fahrenheit. In some embodiments, the outer film 110 retains the adhesive in the interior when the temperature of the pouches 100, the roofing shingles 510, and/or the roof deck 520, and/or when the ambient temperature, is 32 degrees Fahrenheit. In some embodiments, the outer film 110 retains the adhesive in the interior when the temperature of the pouches 100, the roofing shingles 510, and/or the roof deck 520, and/or when the ambient temperature, is 30 degrees Fahrenheit. In some embodiments, the outer film 110 retains the adhesive in the interior when the temperature of the pouches 100, the roofing shingles 510, and/or the roof deck 520, and/or when the ambient temperature, is 20 degrees Fahrenheit.

In some embodiments, the outer film 110 retains the adhesive in the interior when the temperature of the pouches 100, the roofing shingles 510, and/or the roof deck 520, and/or when the ambient temperature, is more than 60 degrees Fahrenheit. In some embodiments, the outer film 110 retains the adhesive in the interior when the temperature of the pouches 100, the roofing shingles 510, and/or the roof deck 520, and/or when the ambient temperature, is more than 50 degrees Fahrenheit. In some embodiments, the outer film 110 retains the adhesive in the interior when the temperature of the pouches 100, the roofing shingles 510, and/or the roof deck 520, and/or when the ambient temperature, is more than 40 degrees Fahrenheit. In some embodiments, the outer film 110 retains the adhesive in the interior when the temperature of the pouches 100, the roofing shingles 510, and/or the roof deck 520, and/or when the ambient temperature, is more than 32 degrees Fahrenheit. In some embodiments, the outer film 110 retains the adhesive in the interior when the temperature of the pouches 100, the roofing shingles 510, and/or the roof deck 520, and/or when the ambient temperature, is more than 30 degrees Fahrenheit. In some embodiments, the outer film 110 retains the adhesive in the interior when the temperature of the pouches 100, the roofing shingles 510, and/or the roof deck 520, and/or when the ambient temperature, is more than 20 degrees Fahrenheit.

In some embodiments, the outer film 110 retains the adhesive in the interior when the temperature of the pouches 100, the roofing shingles 510, and/or the roof deck 520, and/or when the ambient temperature, is less than 60 degrees Fahrenheit. In some embodiments, the outer film 110 retains the adhesive in the interior when the temperature of the pouches 100, the roofing shingles 510, and/or the roof deck 520, and/or when the ambient temperature, is less than 50 degrees Fahrenheit. In some embodiments, the outer film 110 retains the adhesive in the interior when the temperature of the pouches 100, the roofing shingles 510, and/or the roof deck 520, and/or when the ambient temperature, is less than 40 degrees Fahrenheit. In some embodiments, the outer film 110 retains the adhesive in the interior when the temperature of the pouches 100, the roofing shingles 510, and/or the roof deck 520, and/or when the ambient temperature, is less than 32 degrees Fahrenheit. In some embodiments, the outer film 110 retains the adhesive in the interior when the temperature of the pouches 100, the roofing shingles 510, and/or the roof deck 520, and/or when the ambient temperature, is less than 30 degrees Fahrenheit. In some embodiments, the outer film 110 retains the adhesive in the interior when the temperature of the pouches 100, the roofing shingles 510, and/or the roof deck 520, and/or when the ambient temperature, is less than 20 degrees Fahrenheit.

In some embodiments, the pouches 100 are configured to control the direction of flow of the adhesive 120. In some embodiments, the pouches 100 includes strengthened portions that resist bursting more than other portions of the pouches 100. In some embodiments, the strengthened portions are thickened relative to other portions of the pouches 100. In some embodiments, the pouches 100 includes weakened portions, which burst before other portions of the pouches 100. In some embodiments, the weakened portions include lines of weakness. In some embodiments, the pouches 100 are formed and/or positioned such that the adhesive 120 flows along a length of the roofing shingles 510 (for example, along the machine direction of the roofing shingles 510). In some embodiments, the pouches 100 are formed and/or positioned such that the adhesive 120 does not flow so as to be visible on the reveal portion of any of the roofing shingles 510.

In some embodiments, in addition to containing adhesives, the pouches 100 are filled with a quantity of air or other gas, which affects a burst velocity or other characteristic of the bursting or rupturing of the pouches 100. In some embodiments, the pouches 100 are filled with a relatively larger quantity of air or other gas (and thus less of the adhesive 120), thereby increasing a burst velocity. In some embodiment, the pouches 100 is filled with a relatively smaller quantity of air or other gas (and thus relatively more of the adhesive 120), thereby decreasing a burst velocity.

In some embodiments, a method installation comprises obtaining a plurality of adhesive pouches, wherein each pouch comprises an adhesive and an outer film encasing the adhesive, wherein the outer film is configured to rupture when subjected to a sufficient force; placing at least one adhesive pouch between a construction material and a surface; applying a sufficient force to the construction material so the pouch ruptures and results in the adhesive directly contacting both the construction material and the surface; and sealing the construction material to the surface. An example of an application of such embodiment may be tacking a construction material to a surface.

In some embodiments, a method installation comprises obtaining a plurality of adhesive pouches, wherein each pouch comprises an adhesive and an outer film encasing the adhesive, wherein the outer film is configured to rupture when subjected to a sufficient force; placing at least one adhesive pouch between a construction material and a surface; allowing the temperature of the adhesive pouches to rise above the predetermined threshold, causing the outer film to rupture and the adhesive to be released and resulting in the adhesive directly contacting both the construction material and the surface; and sealing the construction material to the surface. An example of an application of such embodiment may be tacking a construction material to a surface.

The following is an example of one embodiment of the present invention. It is understood that this Example is merely illustrative of one embodiment and is not limiting the present invention.

### EXAMPLE

Several sealant pouches were prepared to test their pouch performance upon their application during shingle installation to test the adhesive spreadability when pressed and the ability to provide wind uplift resistance within a short period of time. Four different types of adhesives, a polymer-modified asphaltic sealant containing isopropyl alcohol, and asphaltic roofing cement, a polyurethane-based roofing adhesive, and a solvent-based elastomeric sealant were placed in a sealable pouch of rectangular shape with size ¾×1″ or a hexagonal pouch with size ˜½″ side. The amount sealed was about 2.5˜5 gm. The sample information is shown in Table 1 below.

The example of the pouch sample for the Sample 1 is shown in FIG. 10 and the Sample 4 is shown in FIG. 11. These pouch samples were tested for their pouch performance by adding them on the headlap surface near the nail zone area during shingle installation at 40 degrees Fahrenheit. A second course of shingles was then placed over the first course of shingles and after the shingle installation, the shingles were then walked on to break the pouch. The pouch performance was then evaluated by examining the spreadability of the adhesives and the pouch bursting conditions. Also, shingles having the pouch added were tested for their uplift performance after about 1 hours upon installation to see if the adhesives can provide notable uplift resistance for wind performance. The shingles were tested by the uplift test from ASTM D6381 where the pouch was inserted, see FIG. 12. The performance of the uplift test was then recorded qualitatively, see FIG. 13.

TABLE 1

| | | | | | Uplift |
|---|---|---|---|---|---|
| Sample | Pouch | Pouch | Type of | Pouch | within |
| ID | Shape | Size | adhesives | performance | 1 hr |
| 1 | rectangular | ¾″ × 1″ | asphaltic | Good | no |
| | | | adhesive | | |
| 2 | rectangular | ¾″ × 1″ | asphaltic | fair | no |
| | | | roofing | | |
| | | | cement | | |
| 3 | rectangular | ¾″ × 1″ | polyurethane | fair | yes |
| | | | roofing | | |
| | | | adhesive | | |
| 4 | hexagonal | ~½″ | solvent | poor | no |
| | | | based | | |
| | | | adhesive | | |

Based on the data in Table 1, the uplift resistance of the shingles is impacted by one or more of the following variables: pouch shape, pouch size and type of adhesive.

Variations, modifications, and alterations to embodiments of the present disclosure described above will make themselves apparent to those skilled in the art. All such variations, modifications, alterations, and the like are intended to fall within the spirit and scope of the present disclosure, limited solely by the appended claims.

While several embodiments of the present disclosure have been described, it is understood that these embodiments are illustrative only, and not restrictive, and that many modifications may become apparent to those of ordinary skill in the art. For example, all dimensions discussed herein are provided as examples only, and are intended to be illustrative and not restrictive.

What is claimed is:

1. A method installation, comprising:
obtaining a plurality of roofing shingles,
wherein each shingle of the plurality of shingles includes a reveal portion and a headlap portion;
obtaining a plurality of adhesive pouches,
wherein each pouch comprises:
an adhesive; and
an outer film encasing the adhesive,
wherein the outer film is configured to rupture when subjected to a sufficient force;
installing a first plurality of shingles on a roof so as to form a first row;
placing at least one adhesive pouch on the reveal portion of each shingle in the first row;
installing a second plurality of shingles on the roof to form a second row;
wherein the headlap portion of each shingle of the second row of shingles are installed over the reveal portion of each shingle of the first row resulting in the second row overlapping the first row;
wherein at least a portion of the headlap of the second row directly contacts the adhesive pouch;
applying a sufficient force to the second row of shingles so the pouch ruptures and results in the adhesive directly contacting both the headlap of each shingle of the second row and the reveal portion of each shingle of the first row; and
sealing the second row of shingles to the first row of shingles.

2. The method of claim 1, wherein the adhesive has a viscosity of 50 cps to 2000 cps.

3. The method of claim 1, wherein the adhesive is a hot melt adhesive.

4. The method of claim 1, wherein the adhesive is a solvent-based adhesive.

5. The method of claim 1, wherein the outer film is made of a thermoplastic polymer.

6. The method of claim 5, wherein the thermoplastic polymer is a polyolefin.

7. The method of claim 1, wherein the outer film is configured to degrade, melt, and/or disintegrate at a temperature of more than 100 degrees Fahrenheit.

8. The method of claim 1, wherein the adhesive pouch is textured to prevent rolling or sliding off a sloped roof deck.

9. The method of claim 1, wherein the adhesive adheres the roofing shingles within three hours of release.

10. A method installation, comprising:
obtaining a plurality of roofing shingles,
wherein each shingle of the plurality of shingles includes a reveal portion and a headlap portion;
obtaining a plurality of adhesive pouches,
wherein each pouch comprise:
an adhesive; and
an outer film encasing the adhesive,
wherein the outer film is configured to rupture when subjected to a temperature above a predetermined threshold;
installing a first plurality of shingles on a roof so as to form a first row;
placing at least one adhesive pouch on the reveal portion of each shingle in the first row;
installing a second plurality of shingles on the roof to form a second row;
wherein the headlap portion of each shingle of the second row of shingles are installed over the reveal portion of each shingle of the first row resulting in the second row overlapping the first row;
wherein at least a portion of the headlap of the second row directly contacts the adhesive pouch;
allowing the temperature of the adhesive pouches to rise above the predetermined threshold, causing the outer film to rupture and the adhesive to be released and results in the adhesive directly contacting both the headlap portion of the shingles in the second row and the reveal portion of the shingles in the first row; and
sealing the second row of shingles to the first row of shingles.

11. The method of claim 10, wherein the adhesive has a viscosity of 50 cps to 2000 cps.

12. The method of claim 10, wherein the adhesive is a hot melt adhesive.

13. The method of claim 10, wherein the adhesive is a solvent-based adhesive.

14. The method of claim 10, wherein the outer film is made of a thermoplastic polymer.

15. The method of claim 10, wherein the outer film is configured to degrade, melt, and/or disintegrate at a temperature of more than 100 degrees Fahrenheit.

16. The method of claim 10, wherein the adhesive pouch is textured to prevent rolling or sliding off a sloped roof deck.

17. The method of claim 10, wherein the adhesive adheres the roofing shingles within three hours of release.

18. A sealant pouch, comprising:
an adhesive with a viscosity of 25 cps to 2500 cps; and
an outer film encasing the adhesive, wherein the outer film is configured to rupture when subjected to a temperature above a predetermined threshold.

19. A sealant pouch, comprising:
an adhesive with a viscosity of 25 cps to 2500 cps; and
an outer film encasing the adhesive, wherein the outer film is configured to rupture when subjected to a sufficient force that is equivalent to walking on a shingle.

20. A method of installation comprising:
installing at least one shingle defining a headlap portion and a reveal portion
wherein each having opposed upper and lower surfaces;
placing at least one adhesive pouch on the lower surface of the reveal portion,
wherein the adhesive pouch comprising:
an adhesive with a viscosity of 25 cps to 2500 cps; and
an outer film encasing the adhesive,
wherein the outer film is configured to rupture when subjected to a sufficient force;
applying a sufficient force to the shingle so the pouch ruptures and results in the adhesive directly contacting both the reveal portion; and
sealing the shingle to a roof substate.
